(19) United States
(12) Patent Application Publication
(10) Pub. No.: US 2022/0377551 A1
(43) Pub. Date: Nov. 24, 2022

(54) COMMUNICATION SYSTEM, COMMUNICATION PATH ESTABLISHMENT METHOD, AND NON-TRANSITORY COMPUTER READABLE MEDIUM STORING PATH ESTABLISHMENT PROGRAM

(71) Applicant: NEC Platforms, Ltd., Kawasaki-shi, Takatsu-ku (JP)

(72) Inventor: Tomohiro SATO, Kanagawa (JP)

(73) Assignee: NEC Platforms, Ltd., Kawasaki-shi, Takatsu-ku (JP)

(21) Appl. No.: 17/761,668

(22) PCT Filed: Sep. 9, 2020
(86) PCT No.: PCT/JP2020/034088

§ 371 Date: Mar. 18, 2022

(30) Foreign Application Priority Data
Oct. 4, 2019 (JP) 2019-183433

(51) Int. Cl. H04W 12/069; H04W 12/0431; H04W 12/041

(52) U.S. Cl. CPC H04W 12/069; H04W 12/0431; H04W 12/041; H04W 84/12

(57) ABSTRACT

The AP transmits a verification server certificate signed by a trusted certificate authority to the STA, transmits, upon receipt of the verification request from the STA, the content thereof to the verification server, performs encrypted communication that uses a random number included in the verification response as a seed, and encrypts and transmits the content of the verification response to the STA. The STA generates a common key, checks the content of the response, receives the verification server certificate, verifies whether or not there is a signature of a trusted certificate authority, and encrypts and transmits, to the AP information about a connection destination and the random number as the verification request. The STA decrypts the content of the verification response and checks to see whether information indicating success or failure of the verification and the random number are included, decrypts the content of the verification server certificate.

### TECHNICAL FIELD

The present invention is related to a communication system, a communication path establishment method, and a path establishment program that, while using a wireless Local Area Network (LAN) device and a peripheral device, are capable of preventing a subordinate device (hereinafter, “station” or “STA”) from belonging to anything other than a legitimate access point (AP) designated by an administrator in the situation where access points are manageable.

### BACKGROUND ART

Due to the wide spread of mobile communication terminals such as smartphones and changes in distributed content, data communication amounts in mobile communication networks are explosively increasing. It is a top priority to move (offload) the data traffic of the mobile communication terminals from the mobile communication networks to public wireless LANs provided in various locations.

Accordingly, there is an increasing number of areas where public wireless LANs are available; however, public wireless LANs have security-related problems due to characteristics thereof where anyone can use public wireless LANs. As a result, some users refrain from using public wireless LANs, while others have a risk of becoming a victim of a cyberattack during the use.

Although new mobile communication techniques such as 5G are now available, it will remain unchanged in the future that offloading the traffic to public wireless LANs is desirable. Thus, there is a demand to make public wireless LANs spread more widely.

### CITATION LIST

### Patent Literature

Patent Literature 1: Published Japanese Translation of PCT International Publication for Patent Application, No. 2014-527762

### SUMMARY OF INVENTION

Although public wireless LANs are convenient, there are security-related problems. More specifically, in view of users' convenience, it is desirable to make public wireless LANs available without the need to input a password (i.e., open authentication). However, in an encryption mode for wireless LANs that is generally used at present, the communication is not even encrypted when the open authentication is being used. In that situation, there seems to be extreme danger because a malicious user (hereinafter, “attacker”) is able to intercept the contents of communication of others, by simply capturing wireless LAN packets.

To cope with the circumstances described above, it is possible to use Opportunistic Wireless Encryption (OWE) of WPA3, which is the most up-to-date security standard, because encrypted communication is enabled while open authentication is implemented. As another example, even with WPA2, using an encryption mode that has non-open authentication makes it possible to perform encryption communication. In those situations, the risk of interception may be reduced, because attackers cannot obtain the contents of the communication by simply capturing packets. However, methods used by attackers to intercept communication are not limited to the packet capturing.

For example, examples of the attacking methods include a Man-in-the-Middle (hereinafter, “MitM”) attack. This attacking method is not limited to wireless LANs; however, when MitM is implemented in a wireless LAN, the following method may be used.

At first, an attacker causes his/her device to belong to a legitimate AP (hereinafter, “Real AP”), in the same manner as general users do. Subsequently, while maintaining operations as an STA, the attacker establishes another AP (hereinafter, “Rogue AP”) imitating the legitimate AP. After that, the attacker deceives a legitimate user and tricks an STA of the user, which is to be attacked, into belonging to the Rogue AP. As a result, although the deceived user feels like the STA seemingly belongs to the Real AP, the STA actually belongs to the Rogue AP. The communication to the Real AP is thus routed through the Rogue AP. In this manner, all the communication data of the user becomes susceptible to interception and tampering performed on the attacker's device.

In the MitM, because the communication path of the STA in the wireless LAN is once terminated at the Rogue AP, the encryption in the wireless LAN is once decrypted at the Rogue AP. For this reason, while the MitM is being implemented, encrypting the wireless LAN communication does not make sense as a preventive measure against the interception or the tampering. Further, because the MitM needs to have the attacker's device belong to the Real AP, it is a good idea for the purpose of preventing MitM to inhibit the attacker's device from belonging to the Real AP, i.e., to set the Real AP with authentication. However, with public wireless LANs, because open authentication is used due to the characteristics thereof or because a password can easily be obtained even when non-open authentication is used, guarding against MitM is substantially impossible in the current situation. In other words, the current public wireless LANs have no means for guarding against MitM and are therefore left with the security-related problem.

In Patent Literature 1, a guard against connection to a suspicious AP is provided in the following manner. At first, while an (arbitrary) STA belongs to an (arbitrary) AP on a daily basis, the STA transmits data indicating a reputation of the belonged AP to an evaluation server. The reputation may be, for example, “Verification of an SSL certificate with a trusted website failed”. This example constitutes a bad reputation. In addition, the AP itself transmits data indicating a reputation thereof to the evaluation server. In this situation, the reputation is represented by the number of STAs belonging to the AP, for example. The more STAs belong to an AP, the higher is the reputation. Further, when an STA attempts to connect to an AP, an inquiry about reputations is made to the evaluation server. The evaluation server responds to the STA with an evaluation value of the AP according to a rule derived from machine learning on the basis of accumulated evaluation data. Further, the STA determines whether the connection to the AP is to be continued or not, on the basis of the obtained evaluation value. In this manner, a guard is provided against connecting to APs having bad reputations.

The method described in Patent Literature 1 is excellent in that it is possible to provide the information about a large number of unspecified APs as to whether each AP is good or bad in terms of a general opinion, without the need to trouble AP administrators. However, there are a number of problems. The first problem is that it is not possible to make a trustable assessment, unless a certain amount of data is accumulated as the reputations of an AP to be evaluated. For example, when a public wireless LAN is provided at a newly-opened shop or when an AP has been replaced in an existing public wireless LAN due to aging deterioration or the like, there is hardly any data indicating reputations of the AP, which makes it impossible to make a trustable assessment. The second problem is that, because the APs are assessed on the basis of information from end users, attackers are able to make up fake reputations, by transmitting data of fake reputations to the evaluation server. As a result, for example, it is possible to make reputations of a Real AP worse or to make reputations of a Rogue AP better. In other words, Patent Literature 1 simply discloses a technique for “detecting suspicious APs” and does not actually disclose a technique for guarding against MitM attacks by accurately assessing APs.

Further, users of public wireless LANs use the networks without worrying about whether an AP to which he/she is to connect is newly installed or not. Also, users should be able to connect only to APs that are legitimate with certainty. Even when the information indicating whether an AP is suspicious or not is provided, if the information itself has a possibility of being made up from fake reputations, this method does not make sense in terms of guarding against MitM attacks. As explained herein, the technique disclosed in Patent Literature 1 does not solve the abovementioned problem where public wireless LANs have no means for guarding against MitM attacks. Thus, the problem still remains.

It is an object of the present disclosure to provide a communication system including: an AP; an STA configured to belong to the AP; a verification server configured to perform verification, when the AP has received a verification request from the STA; and a database having registered therein information about the AP being legitimate, wherein when the AP is notified by the STA before having the STA belong thereto that the AP is a compliant AP, the AP transmits a verification server certificate signed by a trusted certificate authority to the STA, upon receipt of the verification request from the STA, the AP transmits content thereof to the verification server and receives a verification response from the verification server by using a secure path, upon receipt of the verification response, the AP performs communication by using, as a wireless LAN encryption scheme to be used between the STA, an encrypted communication scheme that uses a random number included in the verification response as a seed, upon receipt of the verification response, the AP generates a shared key that uses the random number included in the verification response as a seed, and encrypts and transmits content of the verification response to the STA, the STA notifies the AP before belonging to the AP that the STA is a compliant STA, receives the verification server certificate from the AP, and verifies whether the verification server certificate is signed by a trusted certificate authority, when the verification server certificate is trustable, the STA encrypts and transmits, to the AP, information about a connection destination and the random number as the verification request, the encryption using a public key attached to the verification server certificate, upon receipt of the verification response from the AP, the STA generates a common key that uses the random number as a seed, further decrypts the content of the verification response, and checks to see whether the content thereof includes information indicating success or failure of the verification and the random number, when content of the verification is success and the random number is also confirmed, the STA performs the communication by using, as the wireless LAN encryption scheme to be used between the AP, the encrypted communication scheme that uses the random number as the seed, upon receipt of the verification request from the AP, the verification server decrypts the content thereof by using a secret key paired with the public key attached to the verification server certificate signed by the trusted certificate authority and determines success or failure depending on whether or not the database having registered therein the information about the legitimate AP has a record that matches information included in the verification request, and the verification server transmits, to the AP that transmitted the verification request thereto, a result of the determination of the success or failure and the random number included in the verification request as the verification response, by using the secure path.

Further, it is another object of the present disclosure to provide a communication path establishment method, wherein when an AP is notified by an STA before having the STA belong thereto that the AP is a compliant AP, the AP transmits a verification server certificate signed by a trusted certificate authority to the STA, upon receipt of a verification request from the STA, the AP transmits content thereof to a verification server and receives a verification response from the verification server by using a secure path, upon receipt of the verification response, the AP performs communication by using, as a wireless LAN encryption scheme to be used between the STA, an encrypted communication scheme that uses a random number included in the verification response as a seed, upon receipt of the verification response, the AP generates a shared key that uses the random number included in the verification response as a seed, and encrypts and transmits content of the verification response to the STA, the STA notifies the AP before belonging to the AP that the STA is a compliant STA, receives the verification server certificate from the AP, and verifies whether the verification server certificate is signed by a trusted certificate authority, when the verification server certificate is trustable, the STA encrypts and transmits, to the AP, information about a connection destination and the random number as the verification request, the encryption using a public key attached to the verification server certificate, upon receipt of the verification response from the AP, the STA generates a common key that uses the random number as a seed, further decrypts the content of the verification response, and checks to see whether the content thereof includes information indicating success or failure of the verification and the random number, when content of the verification is success and the random number is also confirmed, the STA performs the communication by using, as the wireless LAN encryption scheme to be used between the AP, the encrypted communication scheme that uses the random number as the seed, upon receipt of the verification request from the AP, the verification server decrypts the content thereof by using a secret key paired with the public key attached to the verification server certificate signed by the trusted certificate authority and determines success or failure depending on whether or not a database having registered therein the information about legitimate APs has a record that matches information included in the verification request, and the verification server transmits, to the AP that transmitted the verification request thereto, a result of the determination of the success or failure and the random number included in the verification request as the verification response, by using the secure path.

Further, it is yet another object of the present disclosure to provide a communication path establishment program stored in an AP (access point), wherein when the AP is notified by an STA (a subordinate device) before having the STA belong thereto that the AP is a compliant AP, the AP transmits a verification server certificate signed by a trusted certificate authority to the STA, upon receipt of a verification request from the STA, the AP transmits content thereof to a verification server and receives a verification response from the verification server by using a secure path, upon receipt of the verification response, the AP performs communication by using, as a wireless LAN encryption scheme to be used between the STA, an encrypted communication scheme that uses a random number included in the verification response as a seed, and upon receipt of the verification response, the AP generates a shared key that uses the random number included in the verification response as a seed, and encrypts and transmits content of the verification response to the STA.

Further, it is yet another object of the present disclosure to provide a communication path establishment program stored in an STA (a subordinate device), wherein the STA notifies an AP (access point) before belonging to the AP that the STA is a compliant STA, receives a verification server certificate from the AP, and verifies whether the verification server certificate is signed by a trusted certificate authority, when the verification server certificate is trustable, the STA encrypts and transmits, to the AP, information about a connection destination and a random number as a verification request, the encryption using a public key attached to the verification server certificate, upon receipt of a verification response from the AP, the STA generates a common key that uses the random number as a seed, further decrypts content of the verification response, and checks to see whether the content thereof includes information indicating success or failure of the verification and the random number, and when content of the verification is success and the random number is also confirmed, the STA performs communication by using, as a wireless LAN encryption scheme to be used between the AP, an encrypted communication scheme that uses the random number as a seed.

Further, it is yet another object of the present disclosure to provide a communication path establishment program stored in a verification server, wherein upon receipt of a verification request from an AP (access point), the verification server decrypts content thereof by using a secret key paired with a public key attached to a verification server certificate signed by a trusted certificate authority and determines success or failure depending on whether or not a database having registered therein information about legitimate APs has a record that matches information included in the verification request, and the verification server transmits, to the AP that transmitted the verification request thereto, a result of the determination of the success or failure and a random number included in the verification request as a verification response, by using a secure path.

In the situation where an administrator is able to manage the legitimate APs, the STA is able to belong only to the legitimate APs, even when an attacker has established a fake AP.

### BRIEF DESCRIPTION OF THE DRAWINGS

FIG. 1 is a configuration diagram of a wireless LAN environment according to a first example embodiment.

FIG. 2 is a diagram schematically showing transmission and reception of information according to the first example embodiment.

FIG. 3 is a chart showing an example of an operation flow of an STA according to the first example embodiment.

FIG. 4 is a chart showing an example of an operation flow of a Real AP according to the first example embodiment.

FIG. 5 is a chart showing an example of an operation flow of a verification server according to the first example embodiment.

FIG. 6 is a configuration diagram in which a Real AP and a Rogue AP are established according to the first example embodiment.

FIG. 7 is a drawing showing an example of a radio wave state according to the first example embodiment.

FIG. 8 is a configuration diagram in which an attacker has prepared a fake verification server in addition to a Rogue AP according to the first example embodiment.

FIG. 9 is a configuration diagram showing an example of a specific wireless LAN environment according to the first example embodiment.

FIG. 10 is a table showing primary setting items of APs according to the first example embodiment.

FIG. 11 is a table showing an example of what is recorded in a database of the verification server according to the first example embodiment.

FIG. 12 is a table showing an example of what is recorded in a database of a fake verification server according to the first example embodiment.

### DESCRIPTION OF EMBODIMENTS

### First Example Embodiment

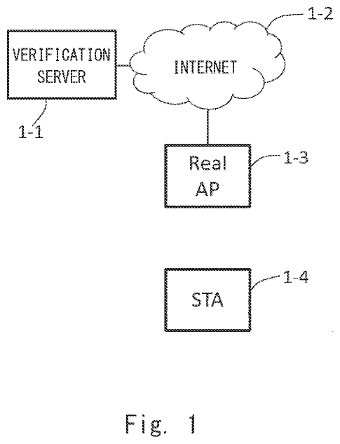

Example embodiments of the present invention will be explained below with reference to the drawings. FIG. 1 presents a configuration diagram of the present invention. A verification server 1-1 is managed by a business operator that installs an AP providing a public wireless LAN and is a server that manages a Real AP 1-3. In FIG. 1, the verification server 1-1 is connected to the Real AP 1-3 via the Internet 1-2; however, the connection does not necessarily have to be routed through the Internet. The Real AP 1-3 is also installed by a business operator, similarly to the verification server 1-1 and is a legitimate AP. Because FIG. 1 is a diagram of a minimum configuration of the present invention, only one Real AP is depicted. In actuality, however, it is expected that two or more Real APs are present. An STA 1-4 is a subordinate terminal of a user of the public wireless LAN.

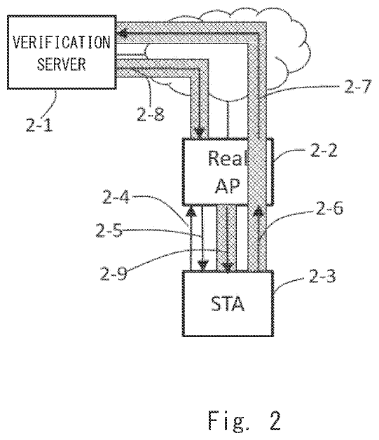

Next, operations in the present invention will be explained, with reference to FIG. 2. In FIG. 2, the paths shown with hatching each indicate that a secure path is established between the devices provided at the two ends thereof. To begin with, before starting to provide a public wireless LAN service, the business operator managing the AP performs preparation as described below.

In the present invention, to perform communication with an STA 2-3 on the basis of a public key encryption scheme using a digital certificate, a verification server 2-1 obtains, in advance, a certificate digitally signed by a trusted certificate authority. (The certificate will hereinafter be referred to as “verification server certificate”.) The verification server certificate includes a public key generated by the verification server 2-1. A secret key paired therewith is installed in the verification server 2-1. Further, the obtained verification server certificate is stored in a Real AP 2-2. In addition, a secure communication path is separately established between the verification server 2-1 and the Real AP 2-2. As for the method for establishing the path, it is acceptable to use a commonly-used method such as a VPN or HTTPS. Further, as information about legitimate APs, a database in the verification server 2-1 registers therein three pieces of information such as Extended Service Set IDentifier (ESSID), Basic Service Set IDentifier (BSSID), and a channel number related to a Basic Service Set (BSS) provided by the Real AP 2-2. The above procedure is performed as the preparation before the public wireless LAN service is started.

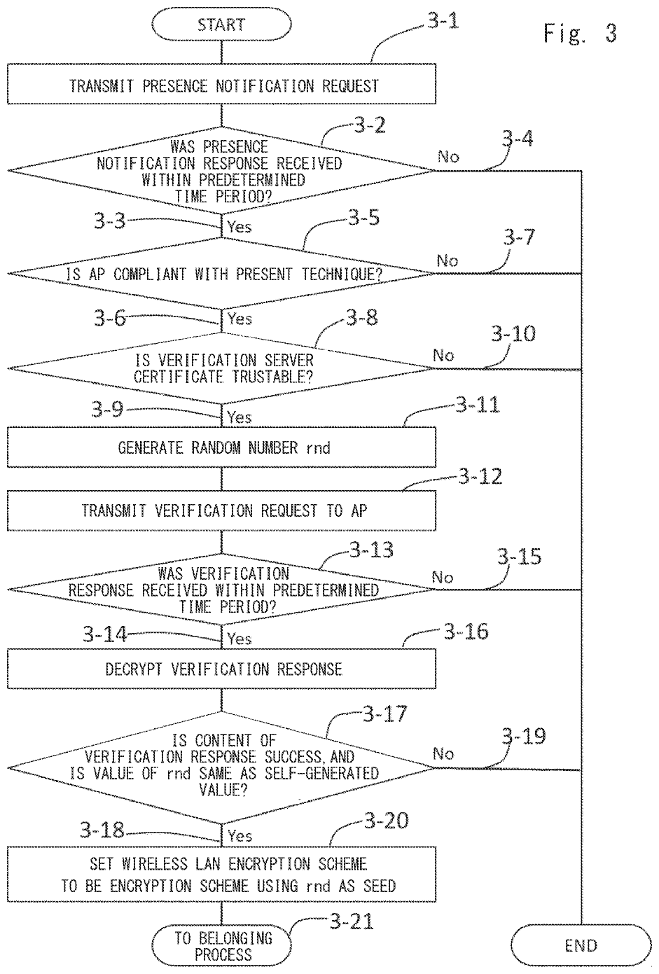

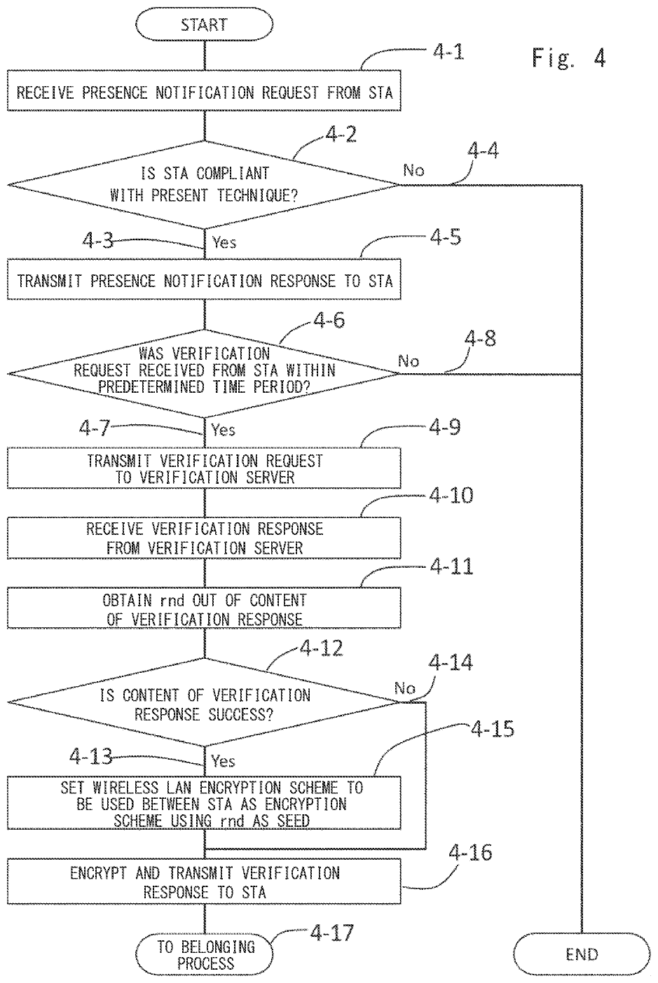

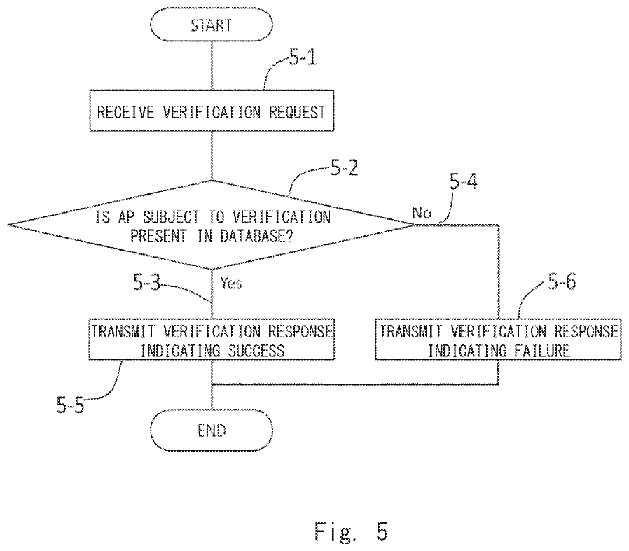

Next, operations after the public wireless LAN service is started will be explained, with reference to FIGS. 2, 3, 4, and 5. FIGS. 3, 4, and 5 are flowcharts related to processes performed by the STA 2-3, the Real AP 2-2, and the verification server 2-1, respectively. Further, because basic operations of the Real AP 2-2 and the STA 2-3 correspond to operations of generic wireless LAN devices, the following will explain only the parts relevant to the present invention.

At first, before starting a wireless LAN connecting process, the STA 2-3 transmits a presence notification request for checking to see whether an AP is present, as a general operation of STAs. When transmitting the presence notification request, the STA 2-3 transmits together therewith data indicating compliance with the technique of the present invention (2-4; 3-1) and waits for a presence notification response from an AP for a predetermined period of time (3-2).

Upon receipt of the presence notification request (4-1), the Real AP 2-2 checks to see whether the STA 2-3 is compliant with the technique of the present invention (4-2). The Real AP 2-2 compliant with the technique of the present invention does not permit any STA that is not compliant with the technique of the present invention to belong thereto. Accordingly, when the STA 2-3 is not compliant with the technique of the present invention, the processes thereafter will not be performed (4-4).

When the STA 2-3 is compliant with the technique of the present invention (4-3), a presence notification response having attached thereto data indicating the compliance with the technique of the present invention and a verification server certificate is transmitted to the STA 2-3 (2-5, 4-5). On the contrary, when no presence notification response is received within the predetermined period of time, the STA 2-3 will not perform the processes thereafter (3-4). Upon receipt of the presence notification response (3-3), it is verified whether or not the Real AP 2-2 is compliant with the technique of the present invention (3-5). When the Real AP 2-2 is not compliant with the technique of the present invention, the processes thereafter will not be performed (3-7).

When the Real AP 2-2 is compliant with the technique of the present invention (3-6), the verification server certificate is obtained out of the received presence notification response, so as to verify whether there is a signature of a trusted certificate authority (3-8). When the result of the verification is in the negative (i.e., not trustable), the processes thereafter will not be performed (3-10).

When it is verified that there is a signature of a trusted certificate authority (3-9), the STA 2-3 generates a random number value rnd (3-11). Further, the STA 2-3 encrypts and transmits, to the Real AP 2-2, four pieces of information such as an ESSID, a BSSID, a channel number, and the rnd related to the BSS to which connection is to be established, the encryption using a public key attached to the verification server certificate (2-6, 3-12).

The three pieces of information other than the rnd are information that can easily be obtained by looking at a beacon or the like issued by the Real AP 2-2 and are types of information that are always obtained in a general operation when an STA belongs to an AP. After transmitting the abovementioned presence notification response, the Real AP 2-2 waits until the data from the STA 2-3 is received for a predetermined period of time (4-6). Upon receipt of the data (4-7), the content thereof is transferred to the verification server 2-1, as a verification request (2-7, 4-9). In this situation, when the data is not received within the predetermined period of time, the processes thereafter will not be performed (4-8).

Upon receipt of the verification request (5-1), the verification server 2-1 at first decrypts the content of the data by using a secret key of its own. Subsequently, the verification server 2-1 compares the obtained information about the ESSID, the BSSID, and the channel number with the database managed thereby and checks to see whether there is data that matches all the three pieces of information (5-2).

When there is data that matches all the three pieces of information (5-3), information indicating success and the rnd are transmitted as a verification response to the Real AP 2-2 via a secure path prepared in advance (2-8, 5-5). On the contrary, when there is no data that matches the information (5-4), information indicating failure and the rnd are transmitted to the Real AP 2-2 via the secure path.

Upon receipt of the verification response (4-10), the Real AP 2-2 obtains the rnd out of the verification response (4-11). After that, it is checked to see whether the verification response indicates success or failure (4-12). When success is indicated (4-13), an encryption scheme is set so as to perform encrypted communication that uses the rnd as a seed, as the wireless LAN communication with the STA 2-3 (4-15). On the contrary, when failure is indicated (4-14), no process to set an encryption scheme is performed. After that, the content of the verification response is encrypted by using the rnd as a common key and transmitted to the STA 2-3 (2-9, 4-16).

After transmitting the verification request to the Real AP 2-2 in process 3-12, the STA 2-3 waits for receiving data from the Real AP 2-2 for a predetermined period of time (3-13). Upon receipt of the data (3-14), the data is decrypted by using the rnd as a common key (3-16). On the contrary, when the data is not received within the predetermined period of time, the processes thereafter will not be performed (3-15).

Subsequently, it is verified whether or not the decrypted content indicates success and whether the value of the rnd (obtained from the decryption) matches a self-generated value (3-17). When this condition is not satisfied (e.g., the decryption itself failed, the content indicates failure, or the value of the rnd does not match the self-generated value), the processes thereafter will not be performed (3-19).

On the contrary, when the abovementioned condition is satisfied (3-18), an encryption scheme is set so as to perform encrypted communication that uses the rnd as a key, as the wireless LAN communication with the Real AP 2-2 (3-20). After that, the STA 2-3 performs a general belonging process as an STA (transmission of an authentication frame and processes thereafter) (3-21), whereas the Real AP 2-2 also performs a general corresponding belonging process as an AP (4-17). As a result, the STA 2-3 has thus completed the process of belonging to the Real AP 2-2.

With the operations described above, the STA has completed belonging to the legitimate AP.

Next, to aid the comprehension of advantageous effects of the present invention, the following will explain how a guard against MitM is provided when a fake AP (=a Rogue AP) is present.

For the Rogue AP, basically, all the parameters including a MAC address are the same as those of the Real AP. However, when an AP of which all the parameters are simply the same was established, the communication would not properly be performed because the communication of the Real AP and the communication of the Rogue AP would be mixed up (Because a wireless LAN packet is a radio wave, the radio wave would physically reach both the Real AP and the Rogue AP, and when the BSSIDs (the MAC addresses) are the same, both of the APs would receive the radio wave). For this reason, the Rogue AP is disguised as a legitimate AP, by making one or more of the parameters different or taking a certain measure to prevent the radio waves from physically being mixed up.

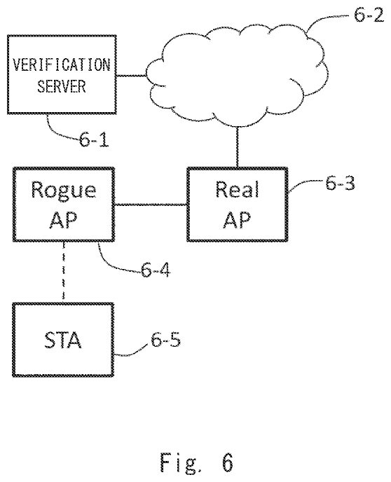

As case 1, an example will be discussed in which a Rogue AP is established in a different channel from that of a Real AP. A configuration is shown in FIG. 6.

In case 1, the BSSIDs of a Real AP 6-3 and a Rogue AP 6-4 are the same; however, because the channels are different, the content of the communication of the Real AP 6-3 and the Rogue AP 6-4 does not get mixed up. The communication path runs as follows: an STA 6-5—the Rogue AP 6-4—the Real AP 6-3—a verification server 6-1.

If the technique of the present invention was not applied, because no process is performed to verify the channel number used by the Rogue AP 6-4, the STA 6-5 would inadvertently belong to the Rogue AP 6-4. In contrast, when the technique of the present invention is applied, the STA 6-5 transmits a verification request including the channel number of the Rogue AP 6-4 to the verification server 6-1 (via the Rogue AP 6-4 and the Real AP 6-3) in process 3-12, so that the verification server 6-1 performs verification including the channel number (5-2). Accordingly, the Rogue AP 6-4 using the channel different from that of the Real AP 6-3 is determined as failure in process 5-2.

Further, the verification request (3-12) transmitted by the STA 6-5 is arranged to include the random number rnd generated by the STA itself before being encrypted with the public key pertaining to the verification server certificate. Accordingly, the Rogue AP 6-4 is not able to tamper the data. (Learning the rnd requires a step of decryption, which is impossible because the Rogue AP 6-3 does not have the secret key.) Even if the Rogue AP 6-4 transmits a fake verification request in place of the proper verification request, because the rnd is inaccurate, a guard works in process 3-17. As explained herein, MitM will not work in case 1.

As case 2, an example will be discussed in which the same channel as the Real AP and a different BSSID are used. Because the BSSIDs are different, the communication does not get mixed up even through the same channel as that of the Real AP is used. In case 2 also, according to the technique of the present invention, because the BSSID is verified at the same time as the channel number is verified, MitM will not work for the same reason as in case 1.

As case 3, an example will be discussed in which a Rogue AP is established while all the parameters including the channel and the BSSID are the same as those of a Real AP. A configuration is again shown in FIG. 6.

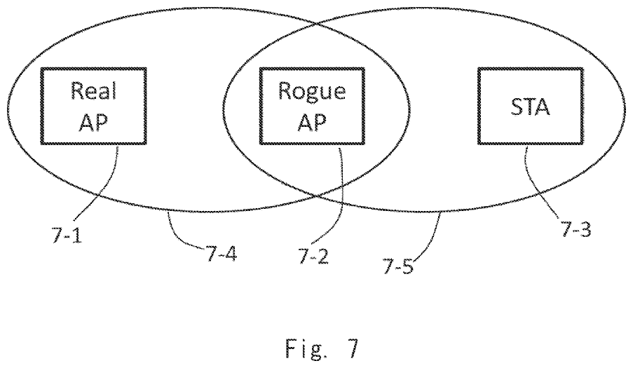

As explained above, when all the parameters are the same as those of the Real AP, the communication gets mixed up; however, when a radio wave situation as shown in FIG. 7 is arranged, it is possible to perform the communication without a mix-up. More specifically, in this arrangement, a radio wave 7-4 of a Real AP 7-1 reaches a Rogue AP 7-2 but does not reach an STA 7-3, whereas a radio wave 7-5 of the STA 7-3 reaches the Rogue AP 7-2 but does not reach the Real AP 7-1.

In this situation, although the verification by the verification server 6-1 cannot spot the disguise, the verification response from the verification server 6-1 is delivered without fail to the Real AP 6-3 via a secure path (2-7, 5-5), but the Rogue AP 6-4 does not receive the content or is unable to decrypt the content. Thus, the Rogue AP 6-4 is similarly unable to learn the rnd, and a guard is provided in process 3-17. Accordingly, MitM will not work in case 3, either.

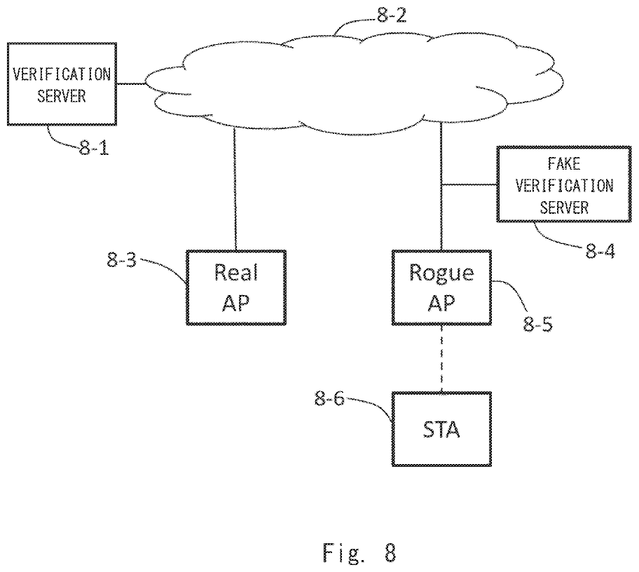

As case 4, an example will be discussed in which an attacker prepares a fake verification server, in addition to a Rogue AP. A configuration in this example is shown in FIG. 8.

In this example, the communication path runs as follows: an STA 8-6—a Rogue AP 8-5—a fake verification server 8-4. In case 4, a guard is provided by the verification process on the verification server certificate in process 3-8. The reasons is that, in order to obtain a digital certificate signed by a trusted certificate authority, it is necessary to bear the cost and to go through a strict screening process. In other words, for being unable to obtain the digital certificate signed by a trusted certificate authority, the attacker has no choice but using a certificate without a signature or a self-signed certificate. Accordingly, a guard is provided in process 3-8. As a result, MitM will not work in case 4, either.

As explained above, the technique of the present invention has extremely high robustness against MitM.

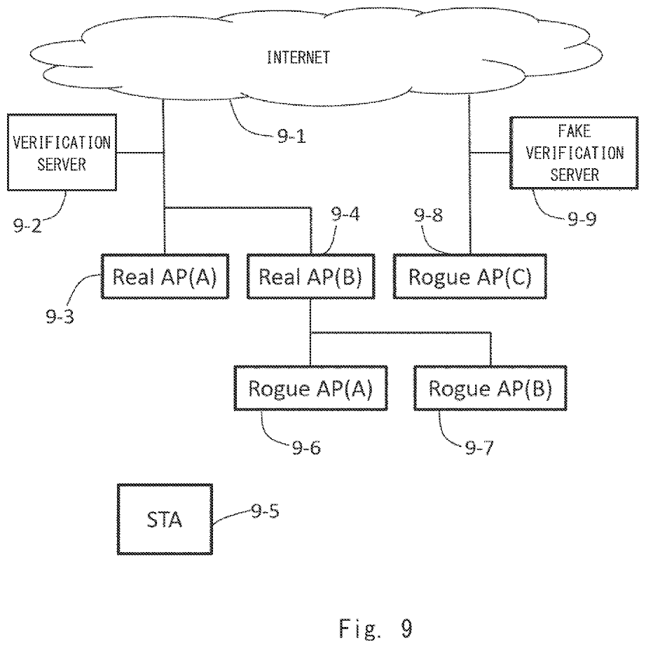

Next, a more specific embodiment example will be explained. A configuration diagram of the embodiment example is shown in FIG. 9.

A verification server 9-2 and Real APs (A, B) 9-3 and 9-4 are prepared and installed by a business operator that provides a public wireless LAN service. An STA 9-5 is a wireless terminal (a smartphone in the present example) of a user who uses the public wireless LAN. It is an object of the present invention to allow the STA 9-5 to belong to the Real AP (A) 9-3 or to the Real AP (B) 9-4 that are legitimate APs prepared by the business operator and to prevent the STA 9-5 from belonging to Rogue APs (A, B, C) 9-6, 9-7, and 9-8. A fake verification server 9-9 and the Rogue APs (A, B, C) 9-6, 9-7, and 9-8 are prepared by an attacker. The attacker is trying to have the STA 9-5 belong to one of the Rogue APs.

In this situation, the Rogue AP (A) 9-6 is the Rogue AP in case 1 described above. The Rogue AP (B) 9-7 is the Rogue AP in case 3 described above. The Rogue AP (C) 9-8 is the Rogue AP in case 4 described above. The Rogue APs (A, B) 9-6 and 9-7 have already belonged to the Real AP (B) 9-4 as subordinate devices.

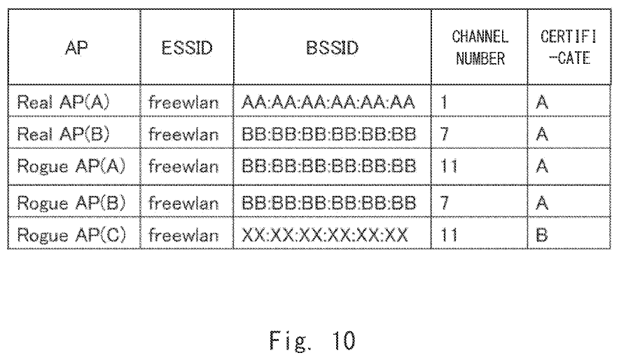

Primary setting items of the APs are shown in FIG. 10. In the present example, a public wireless LAN service is provided under an ESSID “freewlan”. All the Real APs and the Rogue APs use “freewlan” as the ESSID.

As for the BSSIDs, in order to disguise themselves as the Real AP (B) 9-4, the Rogue APs (A, B) 9-6 and 9-7 use the same BSSID as that of the Real AP (B) 9-4. Because the Rogue AP (C) 9-8 is not disguising itself as any specific Real AP, a different BSSID may be used. Because the channel numbers of the Real AP (A) 9-3 and the Real AP (B) 9-4 do not have to be the same as each other, mutually-different channel numbers are used. In order to avoid a communication mix-up with the Real AP (B) 9-4, the Rogue AP (A) 9-6 uses a channel number different from that of the Real AP (B) 9-4. In contrast, as explained above, because there is no radio wave interference, the Rogue AP (B) 9-7 uses the same channel number as that of the Real AP (B) 9-4. As for the Rogue AP (C) 9-8, a different channel is used because there is no need to make the channel the same as the channels of the Real APs similarly to the BSSIDs.

There are two types of verification server certificates, which are called “A” and “B” for the sake of convenience in the explanation. Certificate A is from the verification server 9-2 and is signed by a trusted certificate authority. In contrast, certificate B is from the fake verification server 9-9 and is not signed by a trusted certificate authority.

Next, operations will be explained.

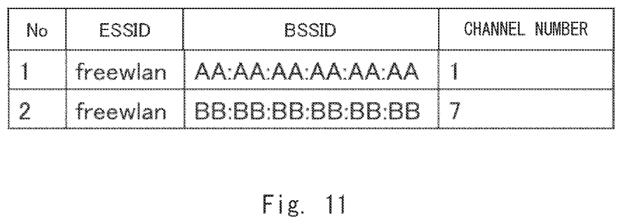

The business operator that provides the public wireless LAN service performs the following processes in advance. To begin with, as a verification server certificate, a digital certificate signed as defined in ITU-T X.509 is obtained together with a corresponding secret key, by requesting a trusted certificate authority. The obtained verification server certificate is stored in the Real APs (A, B) 9-3 and 9-4, whereas the secret key is stored in the verification server 9-2. Further, separately from these, a connection using IPsec is established between the verification server 9-2 and each of the Real APs (A, B) 9-6 and 9-7. Additionally, by using a firewall or the like, the verification server 9-2 blocks any communication other than communication using the connection established with IPsec. Further, in a database in the verification server 9-2, ESSIDs, BSSIDs, and channel numbers of the Real APs (A, B) 9-3 and 9-4 are registered as information about legitimate APs, as shown in FIG. 11.

Next, operations performed when the STA 9-5 is to belong will be explained.

At first, an operation to belong to the Real AP (A) 9-3 will be explained. When a user taps on “freewlan” in the list of ESSIDs displayed on a screen of the STA 9-5, the STA 9-5 at first broadcasts a ProbeRequest designating “freewlan” as an ESSID. In this situation, because a ProbeRequest frame has an area called Vendor Specific where a vendor is able to freely insert data, a character string “READY” is inserted in the area to indicate the compliance with the present invention, before the transmission (3-1).

The Real AP (A) 9-3 receives the ProbeRequest (4-1) and checks to see whether the character string “READY” is present in the Vendor Specific part (4-2). Because the character string “READY” is included (4-3), a ProbeResponse is transmitted (4-5). In this situation, because the ProbeResponse also has a Vendor Specific area, a character string “READY” indicating the compliance with the present invention and the verification server certificate stored in the Real AP (A) 9-3 are inserted in the area in advance, before the transmission.

Upon receipt of the ProbeResponse, the STA 9-5 at first checks to see whether the character string “READY” is present in the Vendor Specific (3-5). Because the presence is confirmed (3-6), it is verified whether the enclosed certificate is trustable (3-8). In the present example, the verification server certificate is signed by the trusted certificate authority, while the trusted certificate authority is configured (commonly at the time of shipment from the factory) in the STA 9-5 in advance, as a trusted root certificate authority. It is therefore determined that the verification server certificate is trustable (3-9).

Subsequently, the STA 9-5 generates a random number value rnd (3-11). In this situation, let us assume that the rnd is 12345678. After that, the STA 9-5 obtains the ESSID, the BSSID, and the channel number related to the Real AP (A) 9-3 and encrypts the information [“freewlan”, AA:AA:AA:AA:AA:AA, 1, 12345678] by using the public key included in the verification server certificate. Subsequently, these pieces of information are stored back into the Vendor Specific of the ProbeRequest and transmitted to the Real AP (A) 9-3 (3-12).

Upon receipt of the ProbeRequest for the second time from the STA 9-5, the Real AP (A) 9-4 transfers the encrypted data transmitted thereto from the STA 9-5, to the verification server without any modification (4-9). The verification server 9-2 receives the data, decrypts the data by using the secret key stored therein, and checks to see whether the database has a record that matches the ESSID, the BSSID, and the channel number that have been transmitted thereto (5-2). In this situation, as shown in FIG. 11, it is understood from the database that record No. 1 has the matching data. Accordingly, the verification server 9-2 transmits [“OK”, 12345678] to the Real AP (A) 9-3, as a verification response (5-5).

It is not until the verification response is received that the Real AP (A) 9-3 learns that the rnd is 12345678 (4-11). Further, the Real AP (A) 9-3 establishes a setting so that the wireless LAN encryption scheme for communicating with the STA 9-5 is to be a WPA2 (AES) scheme and so that the rnd being 12345678 is to be used as a Pre Shared Key (PSK) (4-15). Further, the Real AP (A) 9-3 encrypts the content of the verification response with a common key generated by using the rnd (i.e., 12345678) as a seed and stores and transmits, to the STA 9-5, the encrypted result in the Vendor Specific of the ProbeResponse (4-16).

Upon receipt of the ProbeResponse for the second time, the STA 9-5 obtains the content thereof by performing decryption with a common key generated by using 12345678 as a seed, in the same manner as the Real AP (A) 9-3 did (3-16). The content is [“OK”, 12345678], and because it says “OK” and because the same value as the self-generated rnd is written, it is recognized that the series of inquiries were performed correctly. Thus, a setting is established so that the encryption scheme is to be the WPA2 (AES) scheme and so that 12345678 is to be used as the PSK (3-20).

In this manner, the STA 9-5 and the Real AP (A) 9-3 have been prepared so as to be able to connect to each other. The processes thereafter are the same as the processes in a general wireless LAN connecting process. Authentication is transmitted from the STA 9-5 to the Real AP (A) 9-3, and thus the belonging process is completed.

Next, as for a process of belonging to the Real AP (B) 9-4, because the belonging process is the same as the process in the example with the Real AP (A) 9-3, the explanation thereof will be omitted.

Next, a process of belonging to the Rogue AP (A) 9-6 will be explained. Since the Rogue APs perform the same operations as those of the Real APs, the operation is the same as that in the example with the Real AP (B) 9-4, up to when the verification server 9-2 receives and decrypts a verification request from the Rogue AP (A) 9-6 and performs the determining process (5-2). Thus, the explanation thereof will be omitted.

In the present example, in the process of belonging to the Rogue AP (A) 9-6, the content of the data transmitted as the verification request is [“freewlan”, BB:BB:BB:BB:BB:BB, 11, 12345678]. For this reason, the database in the verification server 9-2 (FIG. 11) has no matching record. Accordingly, as a verification response, the verification server 9-2 transmits [“NG”, 12345678] to the Rogue AP (A) 9-6 (5-6). The processes thereafter also progress similarly to the example of belonging to the Real AP (B) 9-4; however, because it is not “OK” in process 3-17, the process of the subordinate device ends without performing process 3-20. As a result, the STA 9-5 is unable to belong to the Rogue AP (A) 9-6.

Next, a process of belonging to the Rogue AP (B) 9-7 will be explained. In this situation, the content of the data transmitted as a verification request is [“freewlan”, BB:BB:BB:BB:BB:BB, 7, 12345678], and because the data is present in the database (FIG. 11), the processes progress similarly to the example of belonging to the Real AP (B) 9-4. However, because IPsec is not established between the Rogue AP (B) 9-7 and the verification server 9-2, the verification response to the Rogue AP (B) 9-7 is blocked and will not reach the Rogue AP (B) 9-7. As a result, because the Rogue AP (B) 9-7 is unable to proceed with process 4-10 and the processes thereafter, the STA 9-5 will not belong to the Rogue AP (B) 9-7.

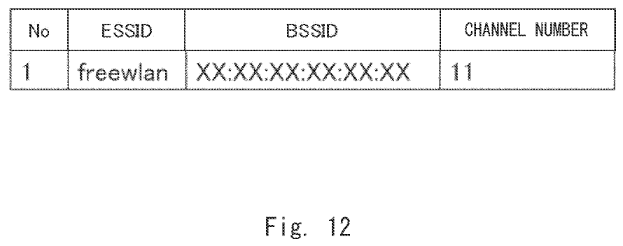

Next, an example of belonging to the Rogue AP (C) 9-8 will be explained. The Rogue AP (C) 9-8 is configured so as to transmit a verification request to the fake verification server 9-9, instead of the verification server 9-2. In this situation, the digital certificate transmitted by the Rogue AP (C) 9-8 in process 4-5 is a certificate from the fake verification server 9-9. The attacker has information about the Rogue AP (C) 9-8 registered in the database of the fake verification server 9-9, as shown in FIG. 12, so as to imitate the mechanism itself of the present technique. However, because the fake verification server certificate is not signed by a trusted certificate authority in the first place, the STA 9-5 is unable to confirm a signature of a trusted certificate authority in process 3-8, and the belonging process thus ends. As a result, the STA 9-5 will not belong to the Rogue AP (C) 9-8.

As explained above, in the situation where an administrator is able to manage the legitimate APs, the STA is able to belong only to the legitimate APs, even when the attacker has established the fake APs.

Further, by using the digital certificate that is digitally signed, it is possible to make it extremely difficult for the attacker to imitate the mechanism itself of the technique of the present invention.

### Second Example Embodiment

In the first example embodiment, the ProbeRequest and the ProbeResponse are used as the verification request and the verification response between the STA and the AP; however, those do not necessarily have to be used. It is sufficient when a verification request and a corresponding response are made before the belonging process is completed. Thus, it is also acceptable to use an authentication packet and an association packet. It is also acceptable to generate packets that are completely original.

Further, although IPsec was used as the secure path between the verification server and the Real APs, IPsec does not necessarily have to be used, either. For example, it is acceptable to address the situation by establishing a TLS session. It is also acceptable to establish a connection with an original line.

Further, although the example was explained in which, in processes 4-15 and 3-20, the wireless LAN encryption scheme is the WPA2 (AES) scheme, while the rnd is used as the PSK, the importance lies in that the encrypted communication is performed by using the rnd as a seed. Accordingly, the WPA2 (AES) scheme does not necessarily have to be used. (For example, WPA3-SAE may be used). Even when a WPA2 (AES) scheme is used, a hash value of the rnd may be used as the PSK, for example, instead of directly using the value of the rnd.

Further, although the explanation was based on the assumption that the database is provided in the verification server, it is also acceptable to provide a database server separately from the verification server. In that situation, however, it should be noted that it is necessary to establish a secure path in advance, also between the verification server and the database server.

Further, in the embodiment example above, the example was explained in which a publicly-known certificate authority is used as the trusted certificate authority. It is, however, also acceptable for the business operator itself to sign the verification server certificate as the certificate authority. In that situation, it is possible to save the cost of requesting a publicly-known trusted certificate authority to issue the certificate; however, needless to say, unless an appropriate arrangement is made, the STA would not recognize the business operator as a trusted certificate authority, and connecting to legitimate APs would not be possible, either. Accordingly, in that situation, it is necessary to store a root certificate generated by the business operator itself in advance, into the main body of the STA, by using certain definitely safe means, e.g., through a member-only application.

As explained above, it is possible to allow the STA to belong only to the legitimate APs, even when an attacker has established a fake AP with one selected from among or a combination of two or more selected from among: changing the method of the verification request or the verification response; changing the type of the secure path; changing the encryption scheme; changing the whereabouts of the database; and changing the certificate authority.

The present invention is not limited to the example embodiments described above. It is possible to apply modifications as appropriate without departing from the gist thereof.

In the example embodiments described above, the present invention was described as a hardware configuration; however, the present invention is not limited to this example. In the present invention, it is possible to realize arbitrary processes, by causing a Central Processing Unit (CPU) to execute a computer program. Further, the abovementioned program may be supplied to the computer, as being stored by using any of various types of non-transitory computer readable media. The non-transitory computer readable media may be any of various types of tangible storage media. Examples of the non-transitory computer readable media include a magnetic recording medium (e.g., a flexible disk, a magnetic tape, or a hard disk drive), a magneto-optical recording medium (e.g., a magneto-optical disk), a CD Read Only Memory (ROM), a CD-R, a CD-R/W, a semiconductor memory (e.g., a mask ROM, a Programmable ROM (PROM), an Erasable PROM (EPROM), a flash ROM, or a Random Access Memory (RAM)). Further, the program may be supplied to the computer via any of various types of transitory computer readable media. Examples of the transitory computer readable media include an electrical signal, an optical signal, and an electromagnetic wave. The transitory computer readable media are able to supply the program to the computer via a wired communication path such as an electrical wire or an optical fiber or via a wireless communication path.

This application is based upon and claims the benefit of priority of Japanese Patent Application No. 2019-183433, filed on Oct. 4, 2019, the entire contents of which are incorporated herein by reference.

### REFERENCE SIGNS LIST

1-1 VERIFICATION SERVER, 1-2 INTERNET, 1-3 REAL AP, 1-4 STA, 2-1 VERIFICATION SERVER, 2-2 REAL AP, 2-3 STA, 6-1 VERIFICATION SERVER, 6-2 INTERNET, 6-3 REAL AP, 6-4 ROGUE AP, 6-5 SPA, 7-1 REAL AP, 7-2 ROGUE AP, 7-3 STA, 8-1 VERIFICATION SERVER, 8-2 INTERNET, 8-3 REAL AP, 8-4 FAKE VERIFICATION SERVER, 8-5 ROGUE AP, 8-6 STA, 9-1 INTERNET, 9-2 VERIFICATION SERVER, 9-3 REAL AP (A), 9-4 REAL AP (B), 9-5 STA, 9-6 ROGUE AP (A), 9-7 ROGUE AP (B), 9-8 ROGUE AP (C), 9-9 FAKE VERIFICATION SERVER

What is claimed is:

1. A communication system comprising:
an AP (access point);
an STA (a subordinate device) configured to belong to the AP;
a verification server configured to perform verification, when the AP has received a verification request from the STA; and
a database having registered therein information about the AP being legitimate, wherein
when the AP is notified by the STA before having the STA belong thereto that the AP is a compliant AP, the AP transmits a verification server certificate signed by a trusted certificate authority to the STA,
upon receipt of the verification request from the STA, the AP transmits content thereof to the verification server and receives a verification response from the verification server by using a secure path,
upon receipt of the verification response, the AP performs communication by using, as a wireless LAN encryption scheme to be used between the STA, an encrypted communication scheme that uses a random number included in the verification response as a seed,
upon receipt of the verification response, the AP generates a shared key that uses the random number included in the verification response as a seed, and encrypts and transmits content of the verification response to the STA,
the STA notifies the AP before belonging to the AP that the STA is a compliant STA, receives the verification server certificate from the AP, and verifies whether the verification server certificate is signed by a trusted certificate authority,
when the verification server certificate is trustable, the STA encrypts and transmits, to the AP, information about a connection destination and the random number as the verification request, the encryption using a public key attached to the verification server certificate,
upon receipt of the verification response from the AP, the STA generates a common key that uses the random number as a seed, further decrypts the content of the verification response, and checks to see whether the content thereof includes information indicating success or failure of the verification and the random number,
when content of the verification is success and the random number is also confirmed, the STA performs the communication by using, as the wireless LAN encryption scheme to be used between the AP, the encrypted communication scheme that uses the random number as the seed,
upon receipt of the verification request from the AP, the verification server decrypts the content thereof by using a secret key paired with the public key attached to the verification server certificate signed by the trusted certificate authority and determines success or failure depending on whether or not the database having registered therein the information about the legitimate AP has a record that matches information included in the verification request, and
the verification server transmits, to the AP that transmitted the verification request thereto, a result of the determination of the success or failure and the random number included in the verification request as the verification response, by using the secure path.

2. The communication system according to claim 1, wherein the database is stored in the verification server.

3. The communication system according to claim 1, wherein
the information about the connection destination transmitted by the STA to the AP as the verification request after being encrypted by using the public key attached to the verification server certificate includes an ESSID, a BSSID, and a channel number of the connection destination, and
when determining the success or failure, the verification server determines the success or failure depending on whether or not the database having registered therein the information about the legitimate AP has a record that matches all of the ESSID, the BSSID, and the channel number included in the verification request.

4. The communication system according to claim 1, wherein
in place of the signature of the trusted certificate authority, a provider of the AP provides a signature and also stores a root certificate in the STA in advance, and
the STA receives the verification server certificate from the AP and further verifies whether the verification server certificate is signed.

5. A communication path establishment method, wherein
when an AP (access point) is notified by an STA (a subordinate device) before having the STA belong thereto that the AP is a compliant AP, the AP transmits a verification server certificate signed by a trusted certificate authority to the STA,
upon receipt of a verification request from the STA, the AP transmits content thereof to a verification server and receives a verification response from the verification server by using a secure path,
upon receipt of the verification response, the AP performs communication by using, as a wireless LAN encryption scheme to be used between the STA, an encrypted communication scheme that uses a random number included in the verification response as a seed,
upon receipt of the verification response, the AP generates a shared key that uses the random number included in the verification response as a seed, and encrypts and transmits content of the verification response to the STA,
the STA notifies the AP before belonging to the AP that the STA is a compliant STA, receives the verification server certificate from the AP, and verifies whether the verification server certificate is signed by a trusted certificate authority,
when the verification server certificate is trustable, the STA encrypts and transmits, to the AP, information about a connection destination and the random number as the verification request, the encryption using a public key attached to the verification server certificate,
upon receipt of the verification response from the AP, the STA generates a common key that uses the random number as a seed, further decrypts the content of the verification response, and checks to see whether the content thereof includes information indicating success or failure of the verification and the random number,
when content of the verification is success and the random number is also confirmed, the STA performs the communication by using, as the wireless LAN encryption scheme to be used between the AP, the encrypted communication scheme that uses the random number as the seed,
upon receipt of the verification request from the AP, the verification server decrypts the content thereof by using a secret key paired with the public key attached to the verification server certificate signed by the trusted certificate authority and determines success or failure depending on whether or not a database having registered therein the information about legitimate APs has a record that matches information included in the verification request, and
the verification server transmits, to the AP that transmitted the verification request thereto, a result of the determination of the success or failure and the random number included in the verification request as the verification response, by using the secure path.

6. The communication path establishment method according to claim 5, wherein
the database is stored in the verification server, and
upon receipt of the verification request from the AP, the verification server determines the success or failure by using records stored in the database stored in the verification server.

7. The communication path establishment method according to claim 5, wherein
the information about the connection destination transmitted by the STA to the AP as the verification request after being encrypted by using the public key attached to the verification server certificate includes an ESSID, a BSSID, and a channel number of the connection destination, and
when determining the success or failure, the verification server determines the success or failure depending on whether or not the database having registered therein the information about the legitimate APs has a record that matches all of the ESSID, the BSSID, and the channel number included in the verification request.

8. A non-transitory computer readable medium storing therein a communication path establishment program stored in an AP (access point), wherein
when the AP is notified by an STA (a subordinate device) before having the STA belong thereto that the AP is a compliant AP, the AP transmits a verification server certificate signed by a trusted certificate authority to the STA,
upon receipt of a verification request from the STA, the AP transmits content thereof to a verification server and receives a verification response from the verification server by using a secure path,
upon receipt of the verification response, the AP performs communication by using, as a wireless LAN encryption scheme to be used between the STA, an encrypted communication scheme that uses a random number included in the verification response as a seed, and
upon receipt of the verification response, the AP generates a shared key that uses the random number included in the verification response as a seed, and encrypts and transmits content of the verification response to the STA.

9.-10. (canceled)
